(19) United States
(12) Patent Application Publication
(10) Pub. No.: US 2006/0209252 A1
(43) Pub. Date: Sep. 21, 2006

(54) Cooking protective eyewear

(76) Inventor: Sandra K. Bush, Conifer, CO (US)

Correspondence Address: SANDRA BUSH, P.O. BOX 1467, CONIFER, CO, 80433, US

(21) Appl. No.: 11/302,898

(22) Filed: Dec. 14, 2005

Related U.S. Application Data
(60) Provisional application No. 60/664,266, filed on Mar. 21, 2005.

(51) Int. Cl. G02C 3/00

(52) U.S. Cl. 351/156

(57) ABSTRACT

The present invention provides cooking protective eyewear particularly, but not exclusively, for use when preparing a variety of foods such as onions, chili peppers, horseradish, etc. The protective eyewear, in a traditional appearance makes use of, in general, a wrap around unitary frame clear plastic lens style. The present invention is the inner member liner formed of a resilient, flexible, malleable, cushioned, sticky self-seal memory cell foam material that is permanently affixed to the inside of the outer frame/lens to create a soft substantial seal that conforms to the wearer's face. The sealed enclosure between the lens and user's eye area is without ventilation that eliminates and/or reduces irritating air borne vapors and juices from reaching the eyes. The prior art search did not disclose any patents that directly reference a cooking application and/or use the proposed material combined design.

References Cited:

| | | | |
|---|---|---|---|
| 6,276,795 | August 2001 | Hall | 351/41, 62 2/428 |
| 6,450,639 | September 2002 | Abraham | 351/41, 62 2/428 |
| 6,233,342 | May 2002 | Fernandez | 351/41, 62 2/428 |
| 6,550,914 | April 2003 | Kopfer | 351/41, 62 2/428 |
| 6,692,124 | February 2004 | Katz | 351/41, 62 2/428 |

### BACKGROUND OF THE INVENTION

Millions of individuals have an uncontrolled adverse physical reaction while preparing certain foods such as onions, chili peppers, horseradish, etc. Their poignant airborne vapors and juices can cause severe eye irritation. There is a need for protective eyewear that is capable of blocking their inescapable caustic vapors, and yet, is also effortless to use.

There are numerous protective eyewear innovations with a wide variety of indoor/outdoor use for both safety and recreational applications. While most eyewear provide a sealed enclosure around the wearer's eyes, ventilation is added to prevent moisture condensation from accumulating becoming clouded up with body temperature, sweating or the like.

The protective eyewear prior art typically include ventilation. U.S. Pat. No. 6,550,914 (Kopfer) discloses eyewear with an inner liner made of a durable material not comprised of foam that one or more deadspaces are created between the eyewear frame and user's eyes. A plurality of baffled vents are provided on the front surface of the insert liner to permit air to pass between the deadspaces. It is this vented design that allow harsh vapors to pass through and into the eyes.

Most protective eyewear innovations rely on direct forward pressure applied from behind the wearer's head and/or ears to complete a sealed enclosure between the lens and the user's eye area.

A common device used to secure protective eyewear is a stretchable elastic type strap worn behind the wearer's head, connecting distal tips of the two eyeglass temples. The strap is confining, awkward, inconvenient to use and not fashionable. Another approach is a pliable, flexible, curved hook type member, mechanism, retainer, extension of the distal tips of the two eyeglass temples, designed to fit in the crease around the back of the wearer's ear. The hook is unattractive, uncomfortable and clumsy.

In order to prevent caustic vapors and airborne juices from entering into the eyes a new and unique designed interface material must be provided along the entire frame/lens surface area without ventilation.

### SUMMARY OF INVENTION

The cooking protective eyewear present invention inner member liner is permanently affixed to, but not limited to a traditional wrap around unitary clear plastic frame/lens style with two connecting temple arms. The present invention comprises an inner member liner formed of a latex or polyurethane viscoelastic memory/recovery cell foam mixture that exhibits a combination of high/low energy losses, high/low temperature density firmness and heat sensitivity. When the protective eyewear is placed into position the present invention inner member liner conforms to the wearer's exact facial shape and creates a soft substantial sealed enclosure between the frame/lens and user's eyes. When the protective eyewear is removed the present invention inner member liner recovers to its original form, ready to be remolded to any other user's exact facial shape.

The eyewear design is without ventilation to prevent irritating vapors/fumes from entering into the eye area.

The protective eyewear is effortless to use. The present invention makes use of a heavy gauge spring tensioner hinge technology that strengthens the temple arms which enable and maintain a uniform snugness against the user's head. The eyewear is designed for easy slide-on, stay-in-place application.

### BRIEF DESCRIPTION OF DRAWINGS

FIG. 1 is a perspective rear-side view of the present invention showing the inner member liner seal without ventilation.

FIG. 2 is a perspective side view of the present invention.

FIG. 3. is a perspective front view of the present invention.

### DETAILED DESCRIPTION OF DRAWINGS

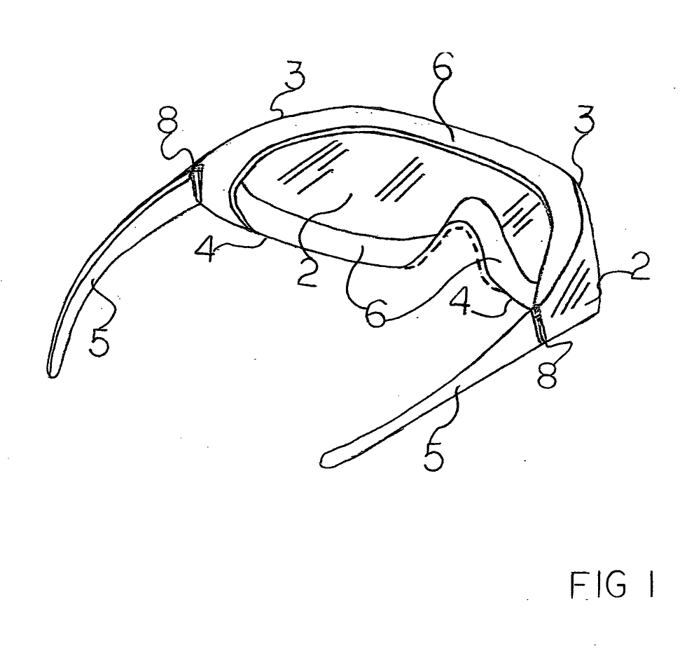

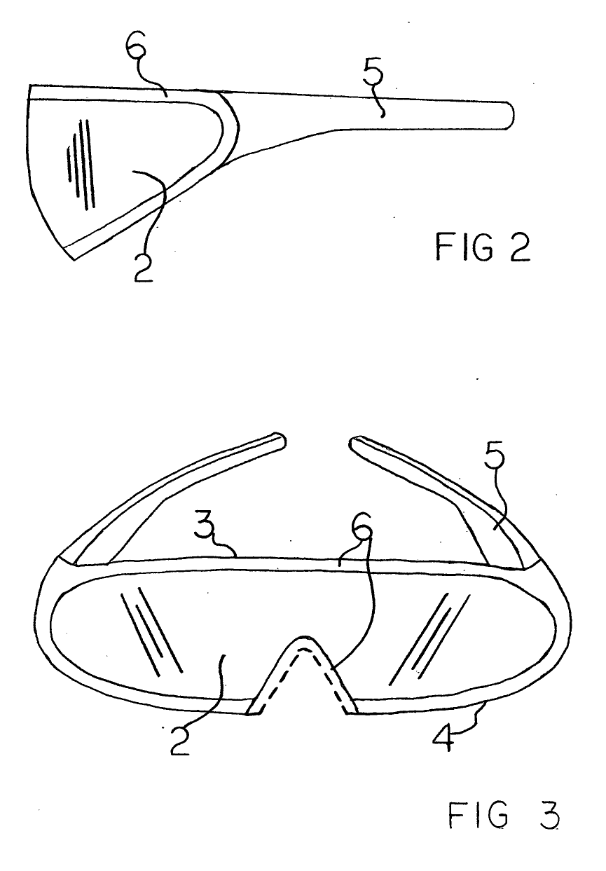

With reference to FIGS. 1-3, a rear-front-side view of the eyewear generally referred to by the numeral 10 includes a frame/lens assembly having left and right sides 3, 4 front and rear lens surfaces 2, top and bottom edges 3, 4 including temple elements and/or extending arms 5 attached by hinge 8 to the right/left sides of the frame so as to form a pair of conventional wrap-around eyewear.

The present invention inner member liner 6 is permanently affixed to the entire inside edge surface of the eyewear's 10 outer frame/lens assembly 3, 4. When eyewear 10 is pressured into position by hinges 8 it conforms to the wearer's exact facial shape 6 and creates a soft substantial sealed enclosure between the lens and user's eyes. When the protective eyewear is removed the present invention inner member liner recovers to its original form, ready to be remolded to any other user's exact facial shape. The designed interface material 6 is without ventilation. It should be noted that prior art typically include ventilation.

The present invention inner member liner 6 is also applicable to other types and styles of eyeglasses, eyewear or goggles.

The eyewear 10 uses a spring tensioner hinge assembly 8 joining the temple arms 5 to the frame/lens 3, 4 that strengthens the temple arms which enable and maintain a uniform snugness against the user's head.

1. The eyewear inner member is a molded liner with a front surface that permanently adheres to the inside of the eyewear outer frame and/or lens assembly, and a back surface that substantially contacts the skin around the wearer's eyes.

2. The eyewear inner member liner of claim 1, wherein: said liner is formed of a latex or polyurethane viscoelastic memory/recovery cell foam mixture that exhibits a combination of high/low energy losses, high/low temperature density firmness and heat sensitivity.

3. The eyewear inner member liner of claim 2, wherein: said liner tensile strength, tear strength, compression set, air permeability, fatigue resistance, support factor, and energy absorbing characteristics may be varied, as can other properties, conditions and processing.

4. The eyewear inner member liner of claim 2, wherein: said liner is of such density firmness that air particles will not penetrate the foam material eliminating and/or reducing irritating air borne vapors and juices from reaching into the eyes.

5. The eyewear inner member liner of claim 2, wherein: said liner, as a whole is a pressure relieving foam material that literally shift position molding to the wearer's exact facial shape.

6. The eyewear inner member liner of claim 2, wherein: said liner is of varying thickness permanently cemented, fused and/or bonded to the entire inside edge of the eyewear outer frame and/or lens assembly.

7. The eyewear inner member liner of claim 6, wherein: when said eyewear is pressured into position by the hinges it conforms to the wearer's exact facial shape and creates a soft substantial sealed enclosure between the lens and user's eyes. When the eyewear is removed the inner member liner recovers to its original form, ready to be remolded to any other user's exact facial shape.

8. The eyewear unitary frame and/or lens assembly of claim 1, wherein: a frame having left and right sides, front and rear surfaces, top and bottom edges including temple elements and/or extending arms attached to the right/left sides of the frame so as to form a pair of conventional eyewear.

9. The eyewear inner member liner of claim 6, wherein: said liner is also applicable to other types and styles of eyeglasses, eyewear or goggles.

10. The eyewear frame and/or lens of claim 8, wherein: clear lens are mounted within a frame and/or a one piece lens and frame assembly.

11. The eyewear frame of claim 8, wherein: the upper frame edge and bridge merge in a sinuous curve.

12. The eyewear lens of claim 8, wherein: the clear plastic lens is one piece, rimless or semi rimless and bridge merge in a bending, curved, all-in-one framework.

13. The eyewear frame of claim 8, wherein: said frame/temple arm construction design is comprised of either a rubber grip like, metal, plastic and/or composite material.

14. The eyewear frame and/or lens of claim 8, wherein: creative decorative designs featuring cooking and gardening related themes are applied or molded into place on the lens, temple arms and/or frames.

15. The eyewear frame of claim 8, wherein: makes use of a variety of heavy gauge spring tensioner hinge technology that strengthens the temple arms which enable and maintain a uniform snugness against the user's head.

16. The eyewear lens of claim 8, wherein: said lens embodies a self-supporting, substantially transparent, streak-free polymer film layer and an anti-fog coating on the film layer, coating one or both sides of the lens.
